(19) United States
(12) Patent Application Publication
(10) Pub. No.: US 2014/0216648 A1
(43) Pub. Date: Aug. 7, 2014

(54) METHOD AND APPARATUS FOR LASER WELDING OF TWO JOINING MEMBERS OF PLASTIC MATERIAL

(71) Applicants: René Geiger, Hallstadt (DE); Frank Brunnecker, Memmelsdorf (DE)

(72) Inventors: René Geiger, Hallstadt (DE); Frank Brunnecker, Memmelsdorf (DE)

(73) Assignee: LPKF LASER & ELECTRONICS AG, Garbsen (DE)

(21) Appl. No.: 14/240,965

(22) PCT Filed: Aug. 20, 2012
(86) PCT No.: PCT/EP2012/066167

§ 371 Date: Feb. 25, 2014

(30) Foreign Application Priority Data
Aug. 25, 2011 (DE) 10 2011 081 554.6

(51) Int. Cl. B29C 65/16

(52) U.S. Cl. CPC B29C 65/1638
USPC 156/272.8; 156/380.9

(57) ABSTRACT

In a method and an apparatus for laser welding of two joining members of plastic material in which a focussed laser beam is emitted into a welding zone in the region of the boundary surfaces of the joining members arranged in such a way as to face one another so as to form a weld seam having a particular seam depth between the joining members, it is provided that the laser power density is modulated during the welding process in a direction of the seam depth in the welding zone.

### CROSS-REFERENCES TO RELATED APPLICATIONS

This application claims the priority of Patent Application Serial No. DE 10 2011 081 554.6 filed on Aug. 25, 2011, pursuant to 35 U.S.C. 119(a)-(d), the content of which is incorporated herein by reference in its entirety as if fully set forth herein.

### FIELD

The invention relates to a method and an apparatus for laser welding of two joining members of plastic material in which a focussed laser beam is emitted into a welding zone in the region of the boundary surfaces of the joining members facing one another so as to form a weld seam having a particular seam depth between the joining members.

### BACKGROUND

Conventional plastic laser welding methods are based on an input of thermal energy into the welding zone by means of the focussed laser beam, causing the joining members to melt so as to form a corresponding weld seam in-between. A common method is the so-called transmission welding in which a joining member transmissive of the laser radiation is disposed on a joining member absorbent of said laser radiation; the laser beam is then emitted through the transmissive joining member onto the absorbent joining member. This causes the latter to melt so that thermal energy is transmitted to the transmissive joining member, causing said joining member to melt as well. As a result, a weld seam is formed in the welding zone in the region of the boundary surfaces of the joining members facing one another.

### BACKGROUND ART

A method and an apparatus for laser transmission welding is known from U.S. 2003/0090562 A1 in which the focus of the laser processing beam is displaceable to compensate for distortions and other faults in the welding plane between the two joining members in a direction perpendicular to the welding plane (z-direction). The component is displaced in a slow movement. A targeted adjustment of the heat input zone by means of high-frequency modulation of the Z-position is not possible by means of this system.

DE 10 2007 036 838 A2 discloses a method for joining different types of document materials so as to form a multilayer security document body such as a debit card, wherein an electromagnetic radiation emitted into a layer structure is modulated. This modulation is an amplitude or frequency modulation; a modulation of the focal position of the radiation in a direction perpendicular to the boundary surface between the individual layers is not shown in this disclosure.

A laser welding method which becomes more and more important in the welding of plastic materials is the so-called butt welding. This method allows for instance two joining members, which are positioned relative to each other in such a way as to form a butt joint and which are transmissive of the laser radiation, to be welded together by melting the boundary surfaces facing one another by means of the laser beam so that a corresponding weld seam can be formed by moving the laser beam along the direction of extension (x-direction) of the butt joint region.

A fundamental problem in laser welding of joining members made of plastic material is the fact that the laser beam needs to be emitted through the surface of one or both joining members in order to reach the welding zone. Depending on the transmission or absorption properties of the plastic materials that are used, the surface may on the one hand be affected by thermal impacts. Another problem may be that the actual welding zone in the region of the boundary surfaces facing one another is rather small relative to the direction of the seam depth (z-direction), with the result that the strength and quality of the seam may be in need of improvement. Consequently, there is a requirement for better controllability of the weld seam formation in the z-direction that is better adapted to the individual workpiece.

### SUMMARY

This object of the invention is on the one hand achieved by a method for laser welding of two joining members of plastic material in which a focussed laser beam is emitted into a welding zone in the region of the boundary surfaces of the joining members facing one another so as to form a weld seam having a particular seam depth between the joining members, wherein the laser power density is modulated during the welding process in a direction of the seam depth in the welding zone, wherein the modulation of the laser power density is performed by a modulation of the focal position of the laser beam in the direction of the seam depth, wherein the modulation frequency of the laser power density in the direction of the seam depth is correlated with the feed rate of the laser beam in a direction of seam extension in such a way that the focus passes over the seam depth of the weld seam at least once when the laser beam is moved in the direction of seam extension. On the other hand, the object of the invention is achieved by an apparatus for laser welding of two joining members of plastic material in which a focussed laser beam is emitted into a welding zone in the region of the boundary surfaces of the joining members facing one another so as to form a weld seam having a particular seam depth between the joining members, in particular for laser welding of two joining members according to the invention, the apparatus comprising a laser beam source, a laser beam guiding and forming unit for forming and guiding the focussed laser beam to the welding zone, comprising a layout of the laser beam source and/or the laser beam guiding and forming unit such that the laser power density can be modulated during the welding process in the direction of the seam depth, wherein the modulation of the laser power density is performed by a modulation of the focal position of the laser beam in the direction of the seam depth, and wherein the modulation frequency of the laser power density in the direction of the seam depth is correlated with a feed rate of the laser beam in the direction of seam extension in such a way that the focus passes over the seam depth of the weld seam at least once when the laser beam is moved in the direction of seam extension.

According thereto, the gist of the present invention is to modulate the laser power density during the welding process in the direction of the seam depth (z-direction). The modulation frequency of the laser power density is defined by a modulation frequency of the laser focal position in the Z-direction and correlated with the feed rate of the laser beam in the direction of seam extension—in other words in the X-direction of a conventional coordinate system—that the focus passes over the seam depth of the weld seam at least once when the laser beam is moved in the direction of seam extension.

As a result, at a slow feed rate, the modulation frequency is correspondingly lower in the X-direction than at a high feed rate. In a so-called quasi-simultaneous welding procedure in which a closed contour line is traced several times at short intervals, the feed rate is much higher; therefore, the modulation frequency needs to be set to a much higher level as well.

In addition to the actual variable power density, said modulation can also take place by means of a variable focal diameter that is modulated accordingly in a particular z-position of the seam depth.

The modulation-dependent variability of the energy input in the z-direction provides a way to advantageously influence the seam geometry in a defined manner So when two equally transparent joining members are butt-welded by means of a 2 μm laser, the energy input in the region of the seam across the component thickness can be optimized by modulating the Z-position of the focus. So instead of a central, spatially limited weld seam having a small seam depth, this modulation in the Z-direction causes a seam to be formed whose depth is increased in the Z-direction, allowing the seam to be extended into the vicinity of the upper and lower abutting edges of the joining members, which results in a maximum sewing depth and a distance from the upper and lower abutting edges that is sufficient to prevent damages to the surface.

A preferred wavelength range of the laser beam for power density modulated laser welding is between 0.7 μm and 2.5 μm, in other words in the infrared range.

In a typical layout of a corresponding apparatus for laser welding which allows the laser power density to be modulated, a corresponding layout of the laser beam source and/or laser beam guiding and forming unit is provided which allows the laser power density to be modulated in the direction of the seam depth during the welding process. If the laser beam guiding and forming unit comprises a focussing unit having a collimating lens and a focussing lens, modulation can be performed by displacing the collimating lens and/or the focussing lens along the transmission direction of the laser beam (optical axis). To this end, one or both lenses are advantageously displaceable by means of a motor. An alternative to this type of modulation is the modulation of the focal position of the laser beam by means of a focussing unit comprising a 3D scanner unit.

Further features, details and advantages of the invention will become apparent from the ensuing description in conjunction with the attached drawings.

### BRIEF DESCRIPTION OF THE DRAWINGS

FIG. 1 shows a perspective schematic cut-out view of two joining members in the welding zone during a butt welding process;

FIGS. 2a to c shows a schematic sectional view of a laser beam guiding and forming unit comprising a displaceable focussing lens for focal position modulation; and

FIGS. 3a to c shows a schematic sectional view of a laser beam guiding and forming unit comprising a displaceable collimating lens for focal position modulation.

### DETAILED DESCRIPTION

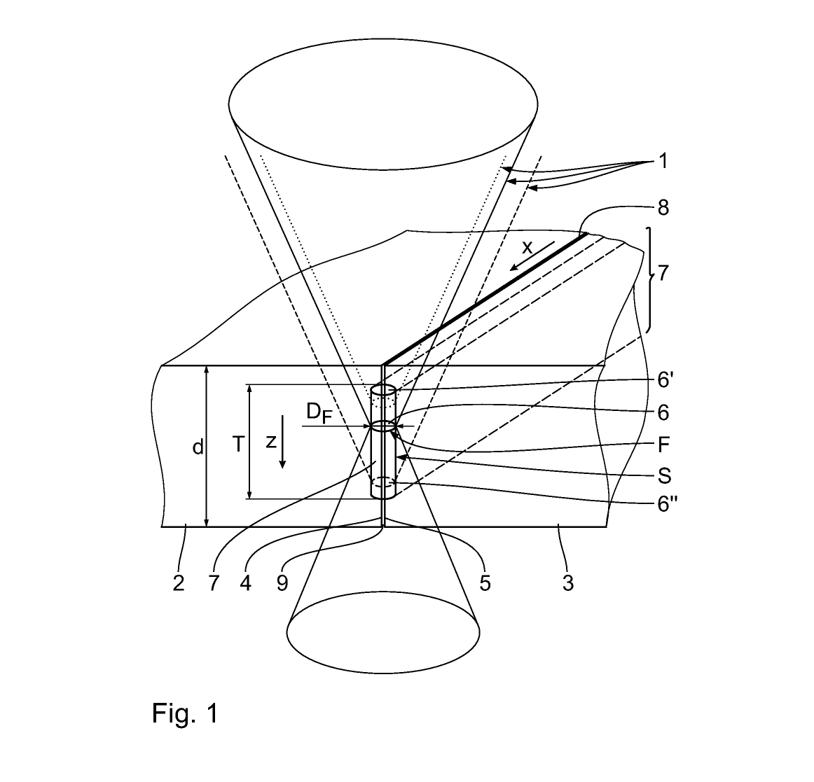

The laser welding method performed with a modulated power density in the direction of the seam depth z shall be explained with reference to FIG. 1. As a rule, this method is performed using a focussed laser beam 1, with the two joining members 2, 3 of a suitable plastic material showing a sufficient degree of transmissivity for the laser beam 1 to pass through. On the other hand, the degree of absorption of the material must be such that part of the laser energy is absorbed by the volume of the joining members 2 so as to be converted into thermal energy required for welding. A suitable laser is for example an infrared laser having a wavelength range of 0.7 μm to 2.5 μm and in particular a wavelength of 2 μm. In FIG. 1, the two joining members 2, 3 are shown in a configuration in which the welding zone, which is—in its entirety—designated by S, is disposed in the region of the boundary surfaces 4, 5 of the joining members 2, 3 which are arranged in such a way as to face one another so that a butt joint is formed.

The position of the focus F of the laser beam 1 shown in FIG. 1 would lead to an extremely localized volume absorption of the laser power only in the region surrounding said focal position 6, resulting in the formation of a correspondingly narrow weld seam 7 having a very limited seam depth T. This is where the invention comes in; by means of constructional measures performed on the laser beam guiding and focussing unit that will be explained in more detail below, the focal position 6 is modulated, in other words moved up and down at a particular frequency, in a z-direction extending parallel to the direction of the seam depth T. This is shown in FIG. 1 by the exemplary focal positions 6′, 6″ shown by dashed or dotted lines.

Generally speaking, the modulation amplitude in the z-direction allows the seam depth T to be extended just up to the upper and lower edges 8, 9 of the boundary surfaces 4, 5 of the joining members 2, 3.

As also indicated by FIG. 1, the laser beam 1 is continuously guided in the x-direction along the weld seam 7 to be formed in the boundary surfaces 4, 5, as is the case in a so-called contour welding procedure. The feed rate vₓ in the x-direction is correlated with the modulation frequency and the displacement rate v_{z} of the focal position 6. Depending on the degree of laser energy absorption achieved by the joining members 2, 3, the focus F should pass over the entire depth T of the weld seam at least once or even several times in order to form a high-quality continuous weld seam 7 across the entire seam depth T in the z- and x-directions. For example, at a focal diameter D_{F} of 0.1 mm, a seam depth of 1 mm, at a thickness d of the joining members 2, 3 of 2 mm and a feed rate vₓ in the x-direction of 100 mm/s, the modulation rate of the focus F needs to be set to 1000 mm/s to ensure that the focus F passes over the entire weld seam 7 across its seam depth T at least once.

FIG. 1 also shows that a suitable adjustment of the seam depth T and its position in the z-direction of the welding zone S allows a sufficient distance from the upper and lower edges 8, 9 of the joining members 2, 3 to be maintained so as to prevent damages to the visible surfaces of the joining members 2, 3.

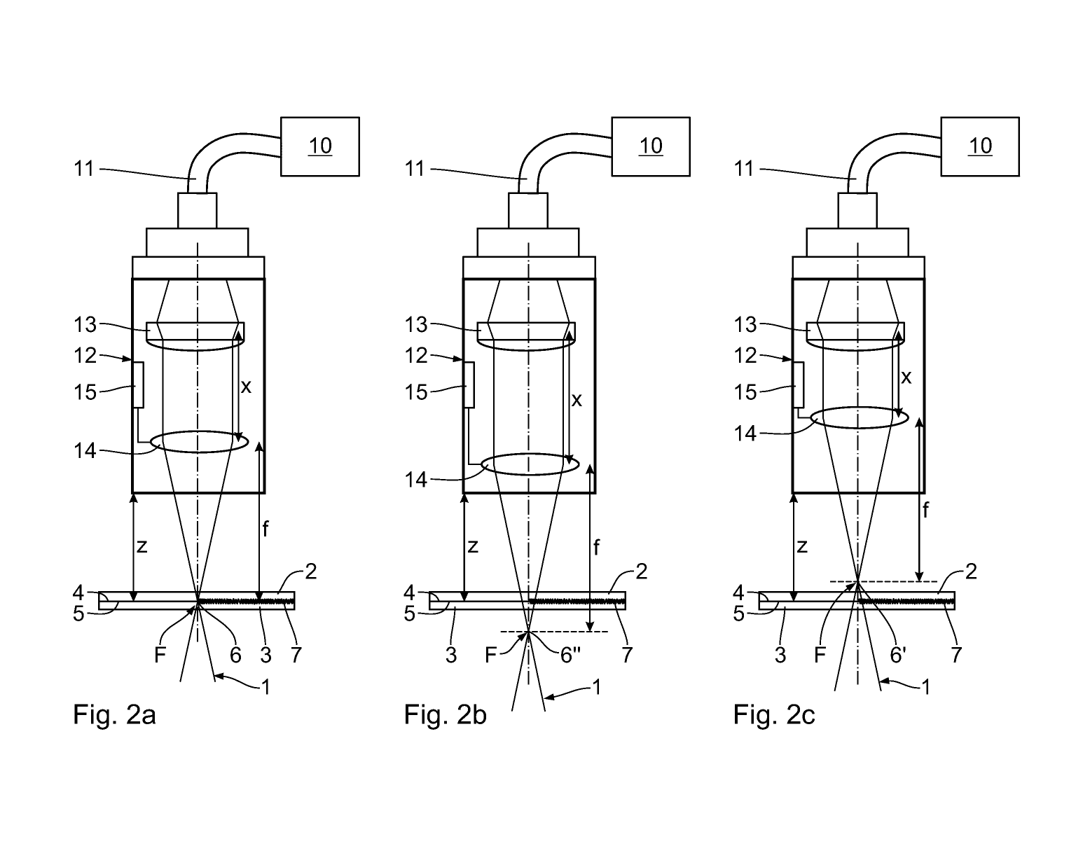

FIGS. 2a to c and 3a to c show an apparatus for laser beam welding in which the joining members 2, 3 are arranged one above the other in a transmission configuration. The apparatuses comprise a schematically shown laser beam source 10 the laser beam 1 of which is guided via a suitable optical waveguide 11 to the laser guiding and forming unit which—in its entirety—is designated by 12. For the sake of simplicity, the latter is referred to as laser processing head 12 in the following description.

In the laser processing head 12, a collimating lens 13 is provided by means of which the diverging laser beam 1 is collimated after exiting the optical waveguide 11 and transmitted to the focussing lens 14. The latter focuses the laser beam 1 in the region of the joining members 2, 3 with a particular focal width f.

In the embodiment according to FIG. 2, the focussing lens 14 is driven for displacement in the direction of the lens axis by means of a motor drive 15. This allows the focus F of the laser beam 1 to be modulated in the z-direction, as described in detail with reference to FIG. 1. In FIG. 2a, the focus is approximately in the region of the boundary surfaces 4, 5 of the two joining members. In the position according to FIG. 2b, the focussing lens 14 is moved away from the collimating lens 13 in the direction of the joining members 2, 3 so that the focus F is displaced correspondingly in the direction towards the lower joining member 3. Here, the corresponding illustration is a schematic view and is therefore strongly exaggerated.

According to FIG. 2c, the focussing lens 14 is displaced beyond the original position according to FIG. 2a towards the collimating lens 13 so that the focus F is displaced upwards in the z-direction.

By means of the drive 15, the focussing lens 15 is therefore positionable in accordance with the desired modulation frequency and amplitude of the focal position 6, 6′, 6″ in such a way as to oscillate in a direction parallel to the z-axis.

It shall be noted that in order to actuate the drive 15 accordingly, the modulation parameters may be varied prior to or during a welding process. So for instance when several types or components are produced by means of one installation, the parameters may be changed prior to the actual welding process. For a corresponding seam examination to be performed, it may be useful, in particular depending on the individual component, to vary modulation parameters along the displacement path in the x-direction in the course of the welding process.

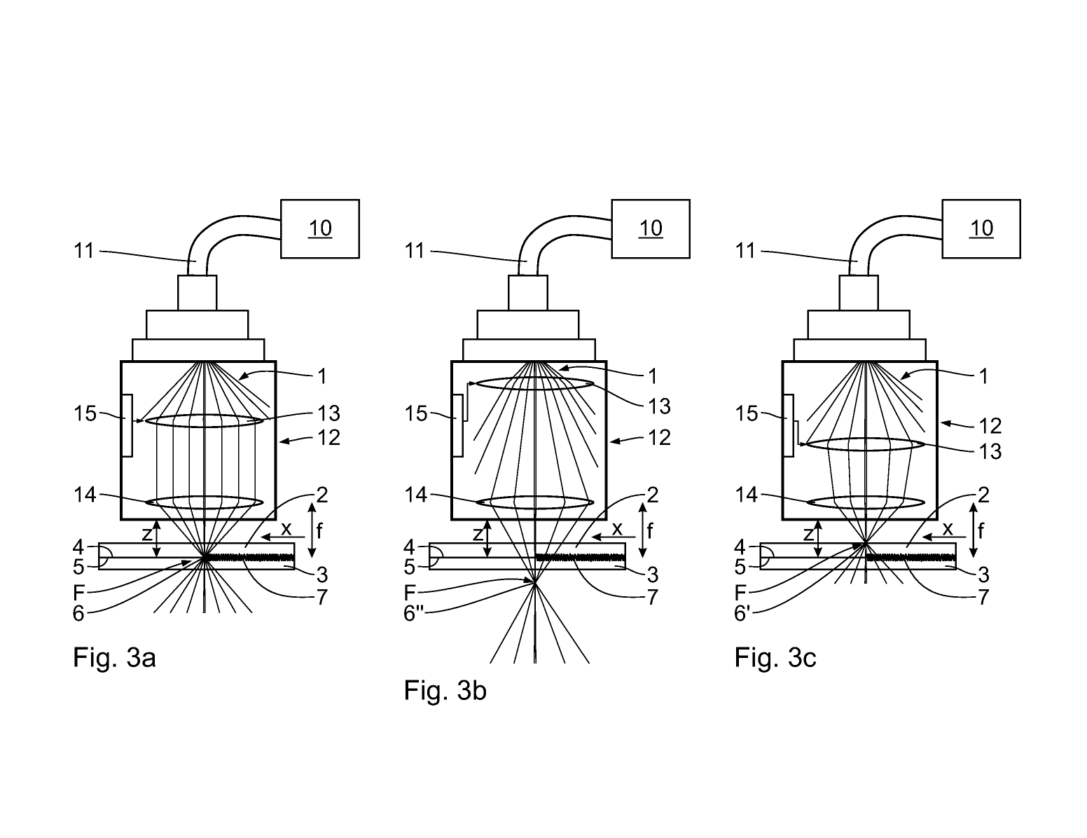

In the exemplary embodiment shown in FIGS. 3a to c, the focussing lens 14 remains in its position while the collimating lens 13 is provided with a drive 15. Starting from the position shown in FIG. 3a in which the collimating and the focussing lens 13, 14 are positioned relative to each other in such a way that the focal position 6 is again in the region of the boundary surfaces 4, 5 of the two joining members 2, 3, the position of the focus F can be modulated by displacing the collimating lens 13 away (FIG. 3b) from or towards the focussing lens 14 (FIG. 3c). According to the strongly exaggerated illustrations of FIGS. 3b and 3c, the shown focal positions 6′ and 6″ are again disposed at a distance from the focal position 6 that is much greater than it is in reality.

1. A method for laser welding of two joining members of plastic material in which a focussed laser beam is emitted into a welding zone in the region of the boundary surfaces of the joining members facing one another so as to form a weld seam having a particular seam depth between the joining members, wherein the laser power density is modulated during the welding process in a direction of the seam depth in the welding zone,
wherein
the modulation of the laser power density is performed by a modulation of the focal position of the laser beam in the direction of the seam depth, wherein the modulation frequency of the laser power density in the direction of the seam depth is correlated with the feed rate of the laser beam in a direction of seam extension in such a way that the focus EF passes over the seam depth of the weld seam at least once when the laser beam is moved in the direction of seam extension.

2. A method according to claim 1, wherein the modulation of the laser power density is performed by a modulation of the diameter of the laser beam in its focus.

3. A method according to claim 1, wherein means of the weld seam, two joining members are joined together which are positioned relative to each other in such a way that a butt joint is formed.

4. A method according to claim 1, wherein the wavelength range of the laser beam is between 0.7 μm and 2.5 μm.

5. An apparatus for laser welding of two joining members of plastic material in which a focussed laser beam is emitted into a welding zone in the region of the boundary surfaces of the joining members facing one another so as to form a weld seam having a particular seam depth between the joining members, the apparatus comprising
a laser beam source,
a laser beam guiding and forming unit for forming and guiding the focussed laser beam to the welding zone,
comprising:
a layout of at least one of the group the laser beam source and the laser beam guiding and forming unit such that the laser power density can be modulated during the welding process in the direction of the seam depth, wherein the modulation of the laser power density is performed by a modulation of the focal position of the laser beam in the direction of the seam depth, and wherein the modulation frequency of the laser power density in the direction of the seam depth is correlated with a feed rate of the laser beam in the direction of seam extension in such a way that the focus passes over the seam depth of the weld seam at least once when the laser beam is moved in the direction of seam extension.

6. An apparatus according to claim 5, wherein the laser beam guiding and forming unit comprises a focussing unit having a collimating lens and a focussing lens, wherein the focal position of the laser beam can be modulated in the direction of the seam depth by a displacement of at least one of the collimating lens and the focussing lens along the beam transmission direction at the rate of modulation.

7. An apparatus according to claim 6, wherein at least one of the group comprising the collimating lens and the focussing lens is displaceable at the rate of modulation along the beam transmission direction by means of a drive.

8. An apparatus according to claim 6, wherein the laser beam guiding and forming unit comprises a focussing unit having a 3D scanning unit for modulation of the focal position of the laser beam.

9. An apparatus according to claim 5, wherein the apparatus is used for laser welding of two joining members according to the invention.

10. A method for laser welding of two joining members of plastic material in which a focussed laser beam is emitted into a welding zone in the region of the boundary surfaces of the joining members facing one another so as to form a weld seam having a particular seam depth between the joining members, using an apparatus comprising a laser beam source, a laser beam guiding and forming unit for forming and guiding the focussed laser beam to the welding zone, a layout of at least one of the group the laser beam source and the laser beam guiding and forming unit such that a laser power density can be modulated during the welding process in the direction of the seam depth, the method comprising:
modulating the laser power density by modulating a focal position of the laser beam in a direction of the seam depth, and
correlating a modulation frequency of the laser power density in the direction of the seam depth with a feed rate of the laser beam in a direction of seam extension such that that the focus passes over the seam depth of the weld seam at least once when the laser beam is moved in the direction of seam extension.
